(19) United States
(12) Patent Application Publication
(10) Pub. No.: US 2006/0173777 A1
(43) Pub. Date: Aug. 3, 2006

(54) Systems and methods for management and analysis of telecommunication access service

(76) Inventors: Mark G. Torres, Birmingham, AL (US); Mary B. Morris, Birmingham, AL (US); Donn P. Sundby, Alabaster, AL (US); Lori W. Bass, Birmingham, AL (US)

Correspondence Address: BAMBI FAIVRE WALTERS, PO BOX 5743, WILLIAMSBURG, VA, 23188, US

(21) Appl. No.: 10/652,293

(22) Filed: Aug. 30, 2003

(51) Int. Cl. G06Q 40/00

(52) U.S. Cl. 705/40

(57) ABSTRACT

This invention provides methods and systems for accessing, integrating, and analyzing multiple telephone rate and billing systems across multiple telephone service regions to execute an access carrier service customer rate and billing detail to effectively service customer accounts, resolve billing questions, and/or develop new revenue products.

### CROSS REFERENCE TO RELATED APPLICATIONS

This application relates to patent application entitled “Data Warehouse for Management and Analysis of Telecommunications Access Services” by Mark G. Torres, Mary B. Morris, Lori W. Bass, and Roland C. Ebright, (Attorney Docket No. 03-BS011 (BS02260)) filed concurrently herewith, and of which the “Brief Summary of the Invention” and “Detailed Description of the Invention” sections are incorporated herein by this reference.

### NOTICE OF COPYRIGHT PROTECTION

A portion of the disclosure of this patent document and its figures contain material subject to copyright protection. The copyright owner has no objection to the facsimile reproduction by anyone of the patent document or the patent disclosure, but otherwise reserves all copyrights whatsoever.

### BACKGROUND OF THE INVENTION

1. Field of the Invention

This invention relates generally to the field of analysis, marketing, billing, and/or management of access carrier services customer accounts, and in particular, to an architecture and method for deriving billing information from multiple billing systems and service regions, for presenting consolidated views of telecommunications access service detail that may include network configuration and availability, a customer rate element, commitment and usage, and for creating and monitoring access carrier service terms and conditions based on information provided in the consolidated views.

2. Description of the Related Art

Before 1984, the Bell telephone system consisted of 22 local Bell telephone companies that were owned by American Telephone and Telegraph (AT&T). AT&T and the local Bell companies sold local, domestic U.S., and international long distance services, as well as customer premises telephone hardware. Customers had one point of contact for all of their telecommunications requirements and AT&T effectively held a monopoly on all telephone services. To meet the accounting needs of this monopoly during this period, AT&T developed billing information technologies and applications that tracked telephone service usage and billing records. These early software and database technologies were relatively primitive and did not allow for the complete integration of billing information across different types of customer accounts, customer operating units (e.g., consumer or small business), and geographic locations (e.g., regional accounting offices, states, and/or or LATAs). Today, these early billing technologies are referred to as legacy technologies.

In 1984, the United States government ordered the divestiture of AT&T, requiring AT&T to transfer ownership of the 22 local phone companies to seven Regional Bell Operating Companies (RBOCs). The seven RBOCs retained the “Bell” logo and the right to sell local and toll calling within local areas. Further, the RBOCs continued to use the legacy technologies to administer customer accounts and track billing activities within their individual regions. During this period, because minimal competition existed within the regions of the RBOCs, the RBOCs held monopolies within their individual regions, giving them little incentive to pursue customers by analyzing customer value across the region and developing targeted marketing programs. Essentially, RBOCs had guaranteed customers who would use the RBOC regardless of discounting or other promotional programs.

However, in 1996, the United States Congress enacted the Telecommunications Act of 1996, opening the Bell territories to competition from long distance vendors, cable companies, local access providers, utility companies, and other RBOCs. As a result, telecommunications service providers (collectively referred to herein as “telcos”) could compete in each other's markets and develop and market new products and services for a wider customer base. Thus, for the first time, RBOCs found it necessary to understand and analyze customer accounts and billing activity within the different RBOC regions and the different legacy systems. Armed with this information, RBOCs could develop customer-specific and/or rate element specific discount programs and promotions based on the revenue derived from that particular customer or rate element. With increased competition, the RBOCs needed to analyze customer value and offer discount programs that encouraged customer retention while maximizing RBOC profit.

To analyze customer value within a service region, RBOCs must consolidate and decipher revenue information across the “artificial boundaries” in a RBOC region. These artificial boundaries are defined by the original legacy systems developed by AT&T. For example, customer operations units (COUs) established by the RBOC handle specific customer types and regional accounting offices (RAOs) within the RBOC region distribute the administrative and accounting functions of the RBOC. Frequently, each of these entities accesses and/or administers information on customers in separate databases. Thus, when a customer falls under more than one customer type and/or within more than one artificial boundary, that customer's rate element and billing information is scattered across several individual databases. Therefore, to completely understand a customer's value to the Telco within the overall region, the rate element and billing information must be consolidated, summarized, and analyzed.

Two principal legacy systems for consolidating, summarizing, and analyzing rate element and billing data are the Carrier Access Billing System (CABS) and the Local Exchange Routing Guide (LERG). CABS maintains billing records for wholesale customers who purchase large blocks of telephone capacity from the RBOCs, usually at rates discounted from retail prices. Typical wholesale customers include access carrier service providers, such as interexchange carriers (i.e., long distance companies), large corporate clients, and/or blocks of consumers seeking lower rates through high volume usage of the system as well as businesses that purchase telephone capacity for resale to individual consumers. LERG maintains current network configuration and scheduled changes to the network. LERG is based on the North American numbering plan and tracks number plan area (e.g., area code) and prefix assignments, also referred to as NPA/NXX assignments. The LERG data specifies the end office and/or tandem office and also specifies routing associated with the end office and/or tandem office. AT&T developed CABS and LERG legacy systems as independent applications, without means for integrating the information they contain. Thus, to understand a customer's potential value, telcos must consult these and several other billing systems to access, gather, and/or analyze the data to effectively service the customer.

### BRIEF SUMMARY OF THE INVENTION

This invention provides methods and systems for accessing, integrating, and analyzing CABS, LERG, and other rate and billing information data to execute an access carrier service customer rate and billing detail to effectively service customer accounts, resolve billing questions, and/or develop new revenue products. This invention summarizes information from multiple telephone rate and billing systems across multiple telephone service regions and provides a Telco with intelligent consolidated views of a customer's telephone usage, rate and billing details, service agreements, and/or service availability. By presenting billing activity, revenue totals, rates, and availability, the intelligent consolidated views give the Telco a comprehensive understanding of a particular customer's value, enabling the Telco to better serve the customer and to formulate customer-specific rate and billing plan terms, conditions, and/or discounts.

According to an embodiment of this invention, a method for executing a carrier access rate and billing detail includes accessing rate and billing records of the customer from a carrier access billing system, accessing network configuration data from a local exchange routing guide, automatically compiling the regional rate record and/or the billing record to create one or more merged rate, rate element, network configuration and billing record, and processing the merged rate and billing record to create an access carrier service rate and billing detail that includes information about service agreement(s), service usage, service rate(s), service availability, type(s) of service, service region(s), and/or customer identifier(s). In further embodiments, the method includes one or more of the following: using the access carrier service rate and billing detail to manage a carrier access customer's billing plan; generating reports of the access carrier service rate and billing detail; and providing means for modifying access carrier service rate and billing detail; displaying alternate promotional codes, rate plans, and/or service agreements.

According to another embodiment of this invention, a carrier access rate and billing system includes a client system containing a client program and a database server containing a database. In response to a request for an access carrier service rate and billing detail through the client system, the client program retrieves selected information from the database, the client program performs any required business logic, and the client program formats and displays the access carrier service rate and billing detail. The client program is an access carrier service rate and billing details manager application and may also include other applications. The information retrieved from the database includes both billing records derived from the carrier access billing system and network configuration detail derived from the local exchange routing guide.

According to another embodiment of this invention, a carrier access rate and billing system includes a client system containing a client program, an application server containing an application server program, and a database server containing a database. In response to a user request for an access carrier service rate and billing detail through the client system, the application server program retrieves selected information from the database, the application server program performs any required business logic, the application server program returns the information to the client program, and the client program formats and displays the access carrier service rate and billing detail. The application server includes business applications and legacy applications. The business application is an access carrier service rate and billing details manager application and may also include other applications. The legacy applications include a carrier access billing system and a local exchange routing guide information system. The carrier access billing system maintains billing information and the local exchange routing guide maintains network configuration information. The information retrieved from the database includes both billing records derived from the carrier access billing system and network configuration detail derived from the local exchange routing guide.

According to another embodiment, this invention provides a computer network architect that includes a carrier access billing system, a local exchange routing guide, and an access carrier service rate and billing details manager application. The access carrier service rate and billing details manager interfaces with the carrier access billing system and the local exchange routing guide, creates and maintains an access customer analysis database (ACAD) derived from the carrier access billing system and the local exchange routing guide information system, creates and maintains a selected view of rate and/or billing records, and support online tasks and offline data maintenance and exchange. Further the access carrier service rate and billing details manager application provides means to establish, monitor, take action on, and/or report on customer level terms and conditions. Still further, the access carrier service rate and billing details manager application includes both online and offline transaction capabilities and internal monitoring functionality capable of triggering both online and offline activity.

Other systems, methods, and/or computer program products according to embodiments will be or become apparent to one with skill in the art upon review of the following figures and detailed description. It is intended that all such additional systems, methods, and/or computer program products be included within this description, be within the scope of this invention, and be protected by the accompanying claims.

### BRIEF DESCRIPTION OF THE DRAWINGS

The above and other embodiments, objects, uses, advantages, and novel features of this invention are more clearly understood by reference to the following description taken in connection with the accompanying figures, in which:

FIG. 1 is a block diagram showing an Access Customer Analysis Database (ACAD) Online Interface module that resides in a computer system according to an embodiment of this invention;

FIG. 2A is a schematic diagram of a three-tier carrier access rate and billing computer network architect according to an embodiment of this invention;

FIG. 2B is a schematic diagram of a two-tier carrier access rate and billing computer network architect according to an embodiment of this invention;

FIG. 3 is a schematic illustrating an overview of an exemplary operating environment of an ACAD Online 316 system according to an embodiment of this invention;

FIG. 4 is a schematic illustrating a logical view of ACAD Online 316 products/plans, other reports, ad-hoc queries, and administration according to an embodiment of this invention; and

FIG. 5-36 are pictures of Graphical User Interfaces (GUIs) according to one or more embodiments of this invention.

### DETAILED DESCRIPTION OF THE INVENTION

This invention now will be described more fully hereinafter with reference to the accompanying drawings, in which exemplary embodiments are shown. This invention may, however, be embodied in many different forms and should not be construed as limited to the embodiments set forth herein; rather, these embodiments are provided so that this disclosure will be thorough and complete, and will fully convey the scope of the invention to those of ordinary skill in the art. Moreover, all statements herein reciting embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure). Thus, for example, it will be appreciated by those skilled in the art that the schematics and the like represent conceptual views of illustrative structures embodying this invention.

In the claims hereof any element expressed as a means for performing a specified function is intended to encompass any way of performing that function including, for example, a combination of elements that performs that function. The invention as defined by such claims resides in the fact that the functionalities provided by the various recited means are combined and brought together in the manner that the claims call for. Applicant thus regards any means that can provide those functionalities as equivalent as those shown herein.

This invention provides methods and systems for creating access carrier service rate and billing details, developing promotional rate and billing products and plans, evaluating impacts of existing and proposed promotional products and plans, and updating information associated with the access carrier service rate and billing details. Thus, this invention supplants the time consuming process of the prior art by quickly compiling customer rate and revenue data from multiple systems and regions, presenting the data in consolidated, selected views of access carrier service rate and billing details, and/or presenting customer-specific promotional rate and billing products. In addition, this invention provides means for executing selected reports and means for updating and/or correcting access carrier service rate and billing detail information. Related methods and systems for accessing, associating, and compiling rate and billing information from multiple billing systems, service regions, and/or regional rate guides are addressed in a concurrently filed patent application entitled “Data Warehouse for Management and Analysis of Telecommunications Access Services” by Mark G. Torres, Mary B. Morris, Lori W. Bass, and Roland C. Ebright, (Attorney Docket No. 03-BS011 (BS02260)) filed concurrently herewith, which is hereby incorporated by reference.

As used herein, the term “client workstation” includes wired and wireless communications devices, such as a mobile phone, a wireless phone, a Wireless Access Protocol (WAP) phone, a satellite phone, a personal computer (PC), a modem, a pager, a digital music device, a digital recording device, a personal digital assistant (PDA), an interactive television, a digital signal processor, and/or a Global Positioning System device. Further, as used herein, the term “data” includes electronic information, such as, for example facsimile, electronic mail (e-mail), text, video, audio, and/or voice in a variety of formats, such as dual tone multi-frequency, digital, analog, and/or others. Additionally, the data may include: (1) executable programs, such as a software application, (2) an address, location, and/or other identifier of the storage location for the data, (3) integrated or otherwise combined files, and/or (4) profiles associated with configuration, authenticity, security, and others. In various embodiments, the data may be stored by the client workstation, a peripheral storage device coupled with the client workstation, a network connected with the client workstation, and/or other connected networks.

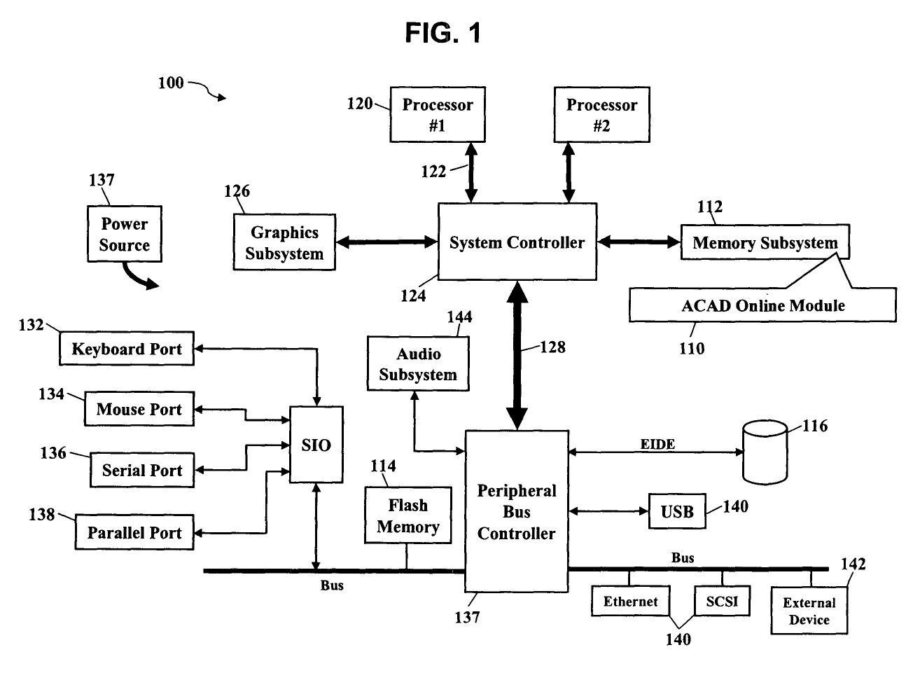

Referring now to the figures, FIG. 1 is a block diagram illustrating an access carrier customer service rates and billing details application manager referred to as an “ACAD Online Module” 110, residing in a client workstation, shown as a personal computer 100. The ACAD Online Module 110 operates within a system memory device. The ACAD Online Module 110, for example, is shown residing in a memory subsystem 112. The ACAD Online Module 110, however, could also reside in flash memory 114 and/or in a peripheral storage device, such as storage device 116. The personal computer 100 also has one or more central processors 120 executing an operating system. The operating system, as is well known, has a set of instructions that control the internal functions of the personal computer 100. A system bus 122 communicates signals, such as data signals, control signals, and address signals, between the central processors 120 and a system controller 124 (typically called a “Northbridge”). The system controller 124 provides a bridging function between the one or more central processors 120, a graphics subsystem 126, the memory subsystem 112, and a PCI (Peripheral Controller Interface) bus 128. The PCI bus 128 is controlled by a Peripheral Bus Controller 130. The Peripheral Bus Controller 130 (typically called a “Southbridge”) is an integrated circuit that serves as an input/output hub for various peripheral ports. These peripheral ports could include, for example, a keyboard port 132, a mouse port 134, a serial port 136 and/or a parallel port 138. Additionally, these peripheral ports would allow the personal computer 100 to communicate with a variety of communications devices through Wired Comm Device Port 140 (such as, SCSI, USB, modem V90+, compact flash slots, Ethernet, and the like) and Wireless Transceiver 142 (such as, the IEEE Wireless standard 802.11, the Industrial and Scientific Band of the electromagnetic spectrum, and Infrared). The Peripheral Bus Controller 130 could also include an audio subsystem 144. Still further, the personal computer 100 may include a power source 160, such as a rechargeable battery, to provide power and allow the personal computer 100 to be portable.

The processor 120 is typically a microprocessor. Advanced Micro Devices, Inc., for example, manufactures a full line of microprocessors, such as the ATHLON™ (ATHLON™ is a trademark of Advanced Micro Devices, Inc., One AMD Place, P.O. Box 3453, Sunnyvale, Calif. 94088-3453, 408.732.2400, 800.538.8450, www.amd.com). Sun Microsystems also designs and manufactures microprocessors (Sun Microsystems, Inc., 901 San Antonio Road, Palo Alto Calif. 94303, www.sun.com). The Intel Corporation manufactures microprocessors (Intel Corporation, 2200 Mission College Blvd., Santa Clara, Calif. 95052-8119, 408.765.8080, www.intel.com). Other manufacturers also offer microprocessors. Such other manufacturers include Motorola, Inc. (1303 East Algonquin Road, P.O. Box A3309 Schaumburg, Ill. 60196, www.Motorola.com), International Business Machines Corp. (New Orchard Road, Armonk, N.Y. 10504, (914) 499-1900, www.ibm.com), and Transmeta Corp. (3940 Freedom Circle, Santa Clara, Calif. 95054, www.transmeta.com).

The preferred operating system is a DOS-based systems. WINDOWS® and WINDOWS NT® are common examples of DOS-based systems (WINDOWS® and WINDOWS NT® are registered trademarks of Microsoft Corporation, One Microsoft Way, Redmond Wash. 98052-6399, 425.882.8080, www.microsoft.com). Other operating systems, however, may be suitable. Such other operating systems would include a LINUX® or a RED HAT® LINUX-based system (LINUX® is a registered trademark of Linus Torvalds and RED HAT® is a registered trademark of Red Hat, Inc., Research Triangle Park, N.C., 1-888-733-4281, www.redhat.com) and Mac® OS (Mac® is a registered trademark of Apple Computer, Inc., 1 Infinite Loop, Cupertino, Calif. 95014, 408.996.1010, www.apple.com). Another operating system would include UNIX®-based system (UNIX® is a registered trademark of The Open Group, 44 Montgomery Street, Suite 960, San Francisco, Calif. 94104, 415.374.8280, www.opengroup.org).

The system memory device (shown as memory subsystem 112, flash memory 114, and/or peripheral storage device 116) may also contain one or more other application programs. For example, another application program may cooperate with the operating system and with a video display unit (via the serial port 136 and/or the parallel port 138) to provide a Graphical User Interface (GUI) for the ACAD Online Module 110. The GUI typically includes a combination of signals communicated along the keyboard port 132 and the mouse port 134. The GUI provides a convenient visual and/or audible interface with the user of the personal computer 100. As is apparent to those of ordinary skill in the art, the selection and arrangement of the ACAD Online Module 110 may be programmed over a variety of alternate mediums, such as, for example, a voice-activated menu prompt.

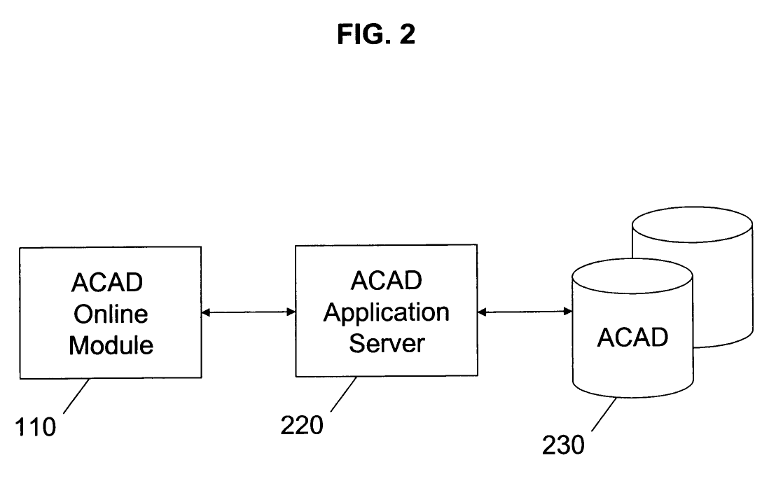

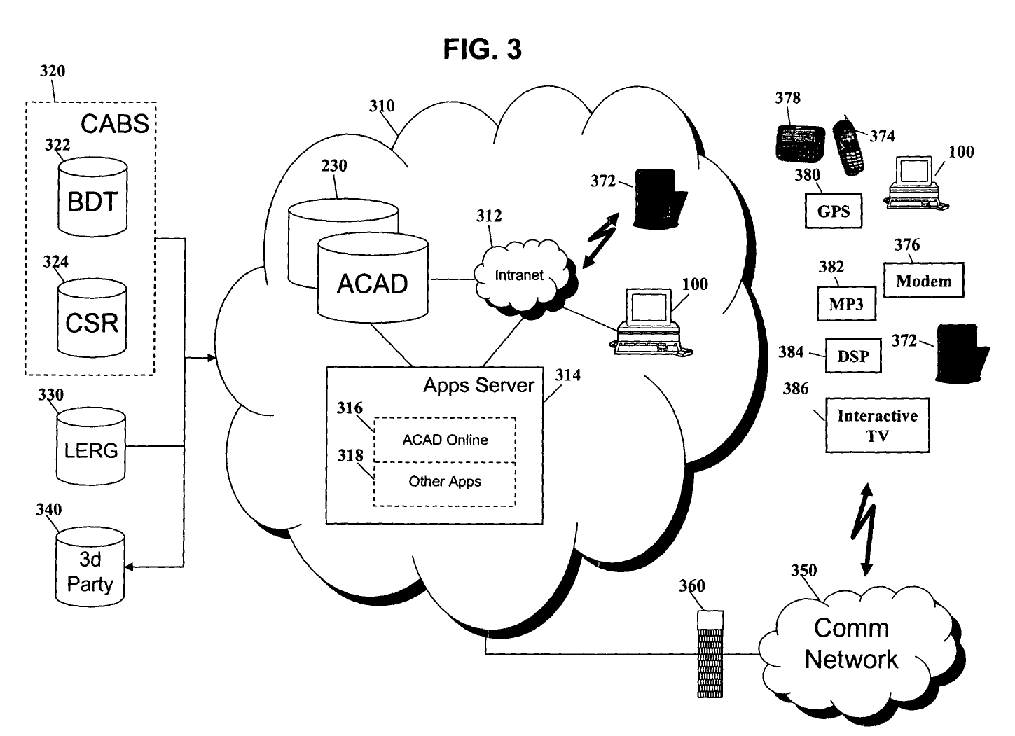

As shown in FIGS. 2A, 2B, and 3, an access carrier customer rate and billing detail system may be based on a distributed, client/server architecture that supports object oriented technology, messaging, transactions, security, system management, and/or reporting. According to an embodiment of this invention, a three-tier technical architecture consists of a client system (shown as reference numerals 100, 372, 374, 376, 378, 380, 382, 384, and 386 in FIG. 3) operating with an ACAD Online Module 110, an application server shown as ACAD application server 220, and a database server operating with ACAD database 230 as shown in FIG. 2A. According to another embodiment of this invention, a two-tier technical architecture consists of a client system (shown as reference numerals 100, 372, 374, 376, 378, 380, 382, 384, and 386 in FIG. 3) operating with an ACAD Online Module 110, and a database server operating with the ACAD database 230 as shown in FIG. 2B. Referring now to FIG. 3, the ACAD Online Module 110 operates on a client workstation that may be a component on a private network, such as business network 310. Alternatively, the client workstation may be stand alone or integrated into a third party workstation, such as a personal digital assistant 372, a mobile phone 374, a modem 376, an interactive pager 378, a global positioning system 380, a digital media player 382 (such as an MP3/4 device), a digital signal processor 384, interactive television 386, and/or stand alone computer 100. If a stand alone or third party workstation is used to gain access to network 310, then the alternate workstation connects to business network 310 through communications network 350 and firewall 360. Whatever hardware and/or software of the client workstation, the client workstation provides a Graphical User Interface (GUI) for viewing and interacting with an ACAD Online application 316. Further, the ACAD application server 220 and the database server are multi-user computer systems, e.g., UNIX-based servers. Still further, it should be understood that multiple client systems and programs might be distributed throughout a network. Furthermore, several application servers running multiple applications may be located at various places, and multiple database servers and databases may be distributed as well.

Typically, a user (e.g., a telco employee) uses his/her workstation, such as personal computer 100 or PDA 372, to interact with ACAD Online Module 110 and gain access via an Intranet 312 to ACAD Online 316 (or alternate other applications shown as reference numeral 318) residing on application server 314. The user navigates through one or more GUIs to login, access, generate, and/or modify access carrier service customer rate and billing detail. ACAD Online 316 retrieves rate and billing data from ACAD database 230, performs any required business logic, and formats and displays information via ACAD Online Module 110 to the client workstation. Further, ACAD database 230 communicates with legacy systems and a third party system 340 to access and selectively store rate and billing information. The legacy systems include Carrier Access Billing System (CABS) 320 databases including Billing Data Tape (BDT) 322 and Customer Service Record file (CSR) 324 and Local Exchange Routing Guide (LERG) 330. The CABS CSR and BDT detail is an industry standard stipulated in the CABS Billing Output Specification (CBOS).

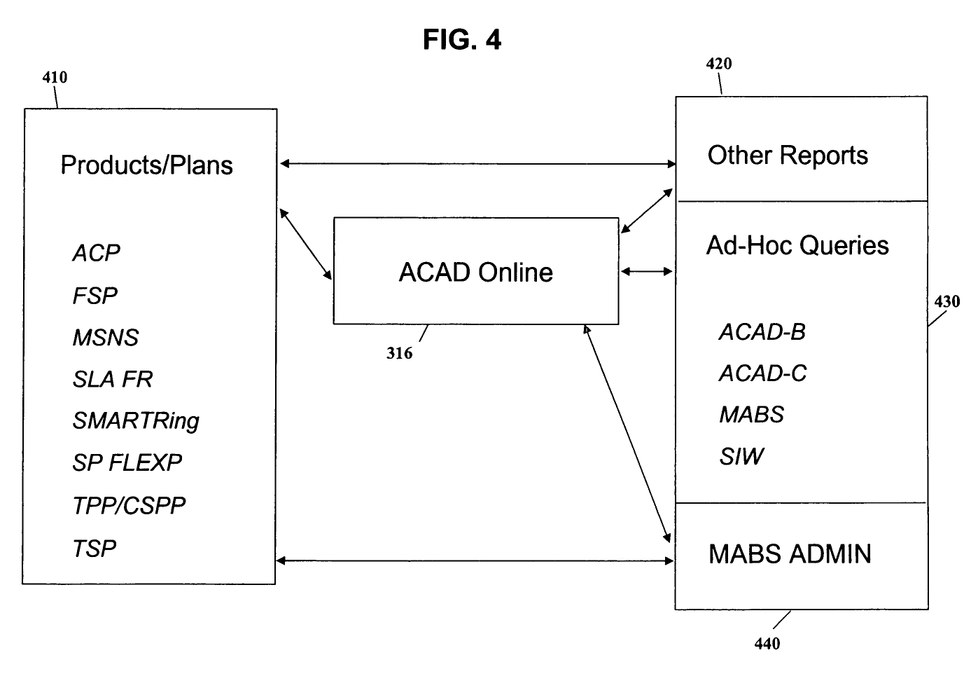

ACAD Online 316 is a tool used by sales, marketing, operations and general staff personnel for standard reporting, sales proposals, customer billing dispute resolution, product analysis & development, updates to discount plans, input of billing adjustments, and/or modifications to rate and billing data. In an embodiment, ACAD Online 316 is a menu driven BrioQuery® application that accesses the ACAD database 230 with an ODBC connection over the business network 310 (typically a wide area network and/or a local area network). ACAD Online 316 utilizes standard BrioQuery® database queries, MS Access® applications, and MS Excel®) spreadsheets to provide a suite of tools that produce carrier access service customer rate and billing detail. As shown in FIG. 4, ACAD Online tool suite includes intelligent reporting capabilities for access service products and plans 410. These products and plans 410 include Area Commitment Plan (ACP), Fast Packet Savings (FSP) plans, Managed Shared Network Services (MSNS), Service Level Agreement (SLA), Self-healing Multi-Nodal Alternate Route Topology Ring (SMARTRing), Special (SP) Pricing Flexibility (SP FLEXP) Contract by Contract Number, Transport Payment Plan/Channel Service Payment Plan (TPP/CSPP), and Transport Savings Plan (TSP). ACAD Online 316 also includes other reports 420 including Circuit Scan (not shown), Class of Service (COS) groups and descriptions, and Credits & Adjust. Further, ACAD Online 316 includes intelligent data models for ad-hoc queries 430 that allows the user to produce rate and revenue detail without requiring the user to have an understanding of the underlying ACAD database schema and architecture. These ad-hoc query models 430 include a total billed revenue model (ACAD-B) built from CABS billing and customer service data, and a circuit level detail model (ACAD-C) built from CABS customer service data, MABS built from CABS data stored on legacy system tables, and Strategic Information Warehouse (SIW) containing account, address, billing, Universal Service Order Code (USOC), and working line service/product information of RBOC Customer Records Information System (CRIS) residential and business customer's local service. Still farther, ACAD Online 316 includes MABS administration 440 that can only be accessed by a select group of users and/or administrators for additional processing and creation of customer billing credits.

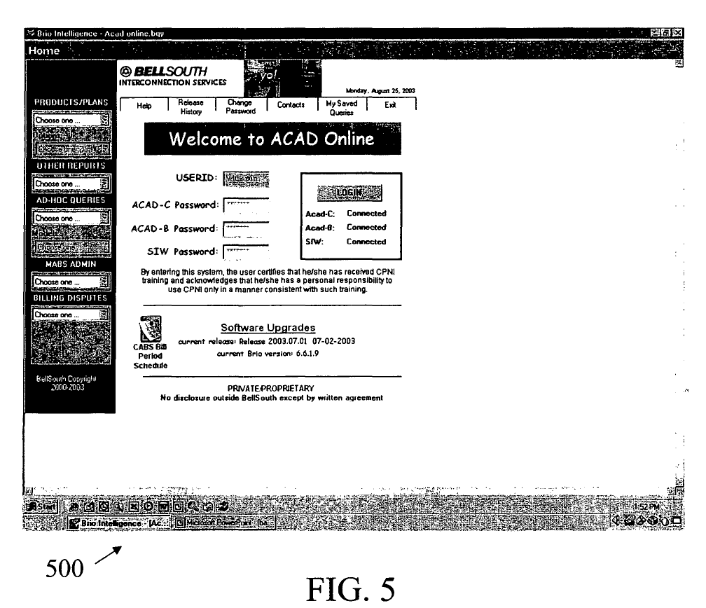

An exemplary overview of ACAD Online 316 including exemplary carrier access service customer rate and billing details will now be discussed with reference to FIGS. 5-35. FIG. 5 illustrates an exemplary ACAC Online entry screen 500. On its main screen (“Home”), the user must first log into the appropriate databases before navigating to any other part of the system. The screen 500 provides data security by limiting access to those users with the proper database permissions. The screen 500 contains queries that identify the current bill periods and/or months for each of the databases. This information can be used by other executable programs in the system. This entry screen also contains global scripts that are used throughout ACAD Online 316. This global scripts remain open “behind the scenes” during the entire session so that these scripts are available for use by other documents.

Text labels in the top bar can be clicked to activate other sections within the BrioQuery® that provide the following functionality:
Help—Provides command buttons that open User Guides for databases ACAD-B and ACAD-C and for the ACAD Online 316 application. Also, Help provides dropdowns that correspond to the various sidebar options; when selected, the database(s) the user must log into for that option are displayed. This screen also contains command buttons that open documents describing how to install a driver and how to create PDF for many of the details (i.e., generated pivot reports) described below.
History—Provides a listbox of ACAD Online 316 releases and their install dates. When selected, text labels detail the changes included in that release.
Change Password—Provides a means for the user to change their ACAD-B, ACAD-C, and/or database passwords before they expire.
Contacts—Provides a list of contacts.

Finally, a text label entitled “Upgrade Software” will take the user to a screen which displays information about the current ACAD Online 316 release; when the command button “Upgrade NOW” is clicked, any new software associated with that release is automatically installed.

ACAD Products/Plans

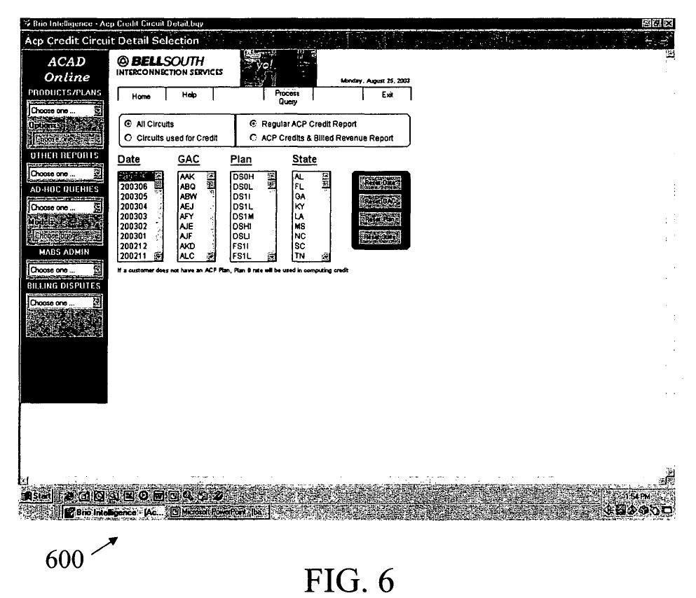

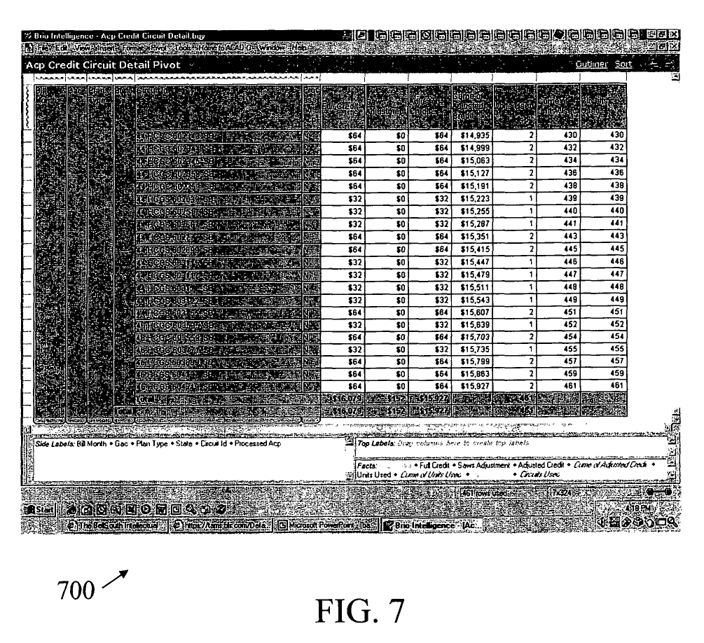

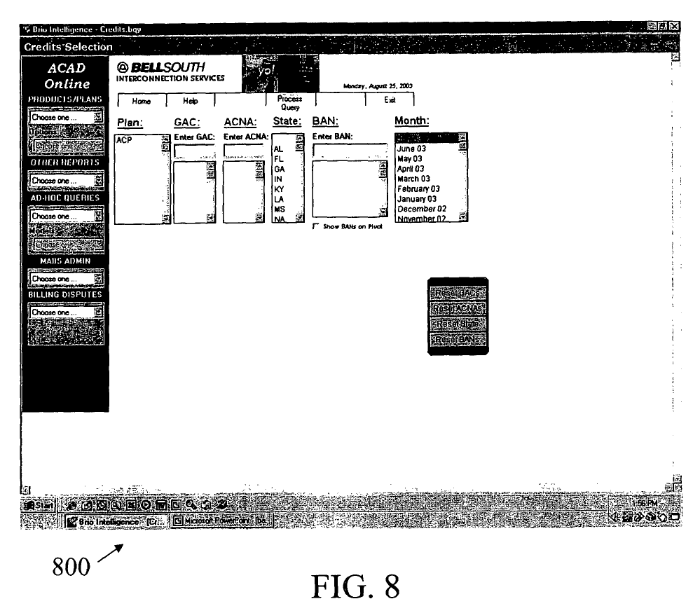

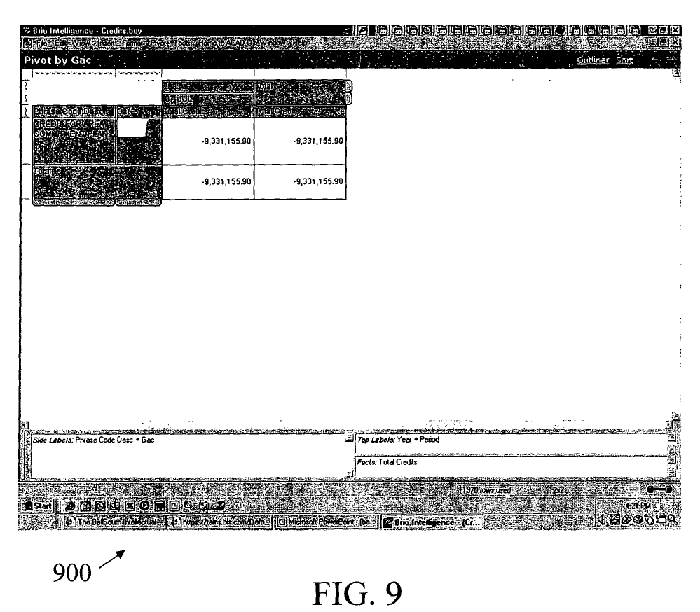

FIG. 6 illustrates a GUI for an Area Commitment Plan (ACP) credit information selection screen 600 for selecting month, GAC, plan type, state and circuit level. The screen 600 is sourced from ACP data extracted from CABS. The screen 600 provides options to select the Date, Group Access Code (GAC), Plan, and State that are used to define the detail selection criteria. Once the query is processed, a pivot ACP Credit Circuit Detail is placed at the bottom of the screen with a pointer to the pivot section. FIG. 7 illustrates the resulting ACP Credit Circuit Detail 700. FIG. 8 shows a GUI for an ACP plan Other Charges and Credits (OC&C) credits selection screen 800 stored in ACAD-B database and produces an ACP plan OC&C credits detail 900 shown in FIG. 9 based on the selections.

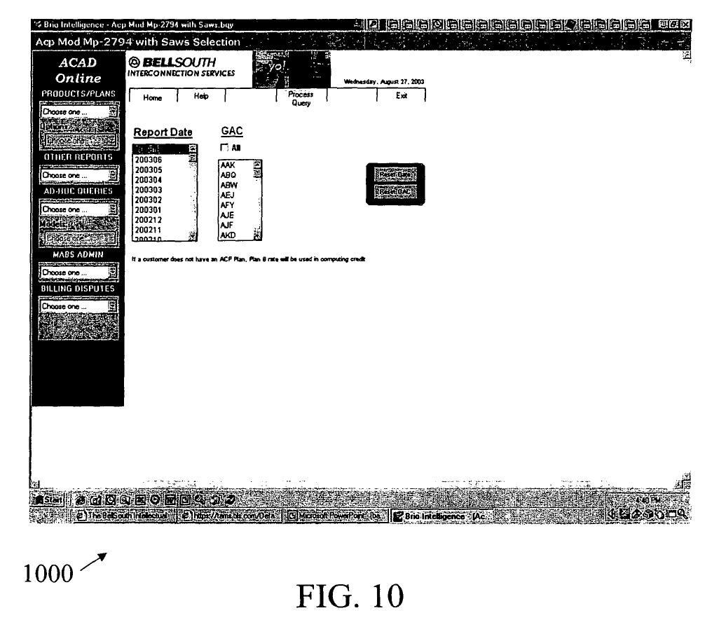

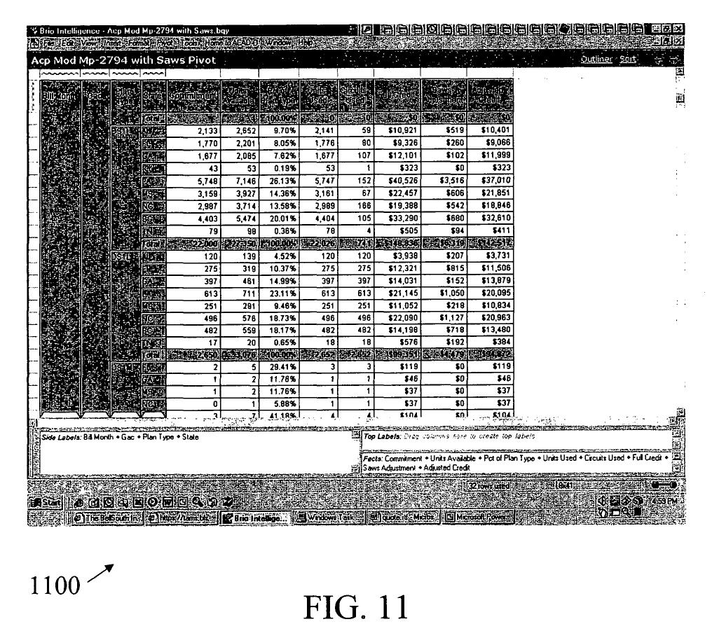

FIG. 10 depicts a GUI for a modified version of a Mechanically Produced (MP-2794) report (ACP MOD MP-2794) selection screen 1000. The ACP MOD MP-2794 selection screen 1000 displays the Carrier ACP commitment and adjustment detail such as units available, units used, commitments and credits by month, GAC and State. The ACP MOD MP-2794 selection screen 1000 is sourced from the ACP Billing and Plan data extracted from CABS tables. The ACP MOD MP-2794 selection screen 1000 provides options to select the date and GAC that are used to define the report selection criteria. Once the query is processed, the user has the choice to view an ACP MOD MP-2794 detail shown as reference numeral 1100 in FIG. 11 or printing to a file. The ACP MOD MP-2794 detail 1100 is grouped by plan type and contains graphs comparing commitments to units available. In addition, a condensed version of the detail 1100 can be exported to a Microsoft Excel® spreadsheet.

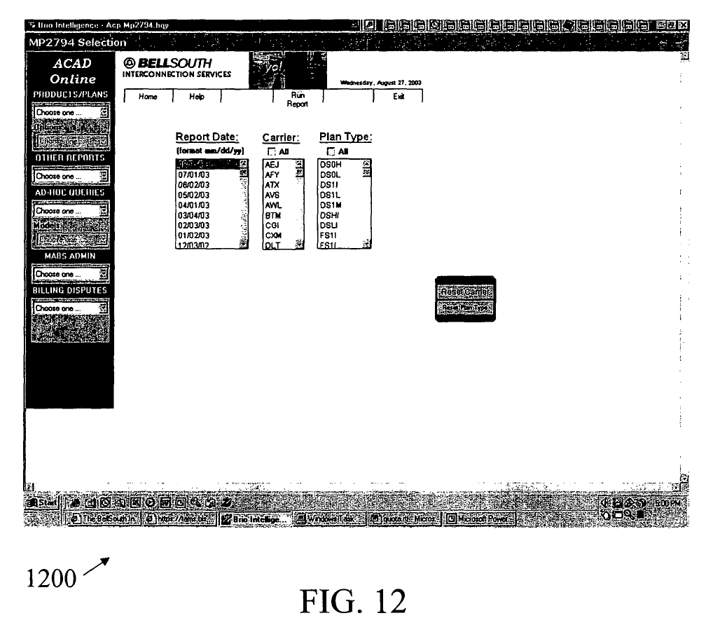

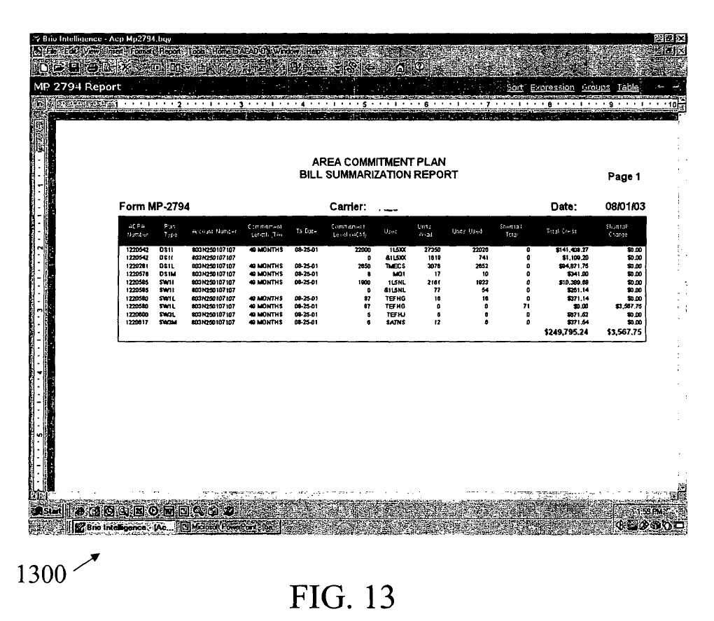

FIG. 12 illustrates a GUI for an ACP MP-2794 selection screen 1200. The ACP MP-2794 selection screen 1200 reports by Carrier showing the ACP Plan Type, the customer's commitment level, the units used and available, the total credit, and any shortfall charges. FIG. 13 is a GUI of the resulting MP-2794 detail 1300.

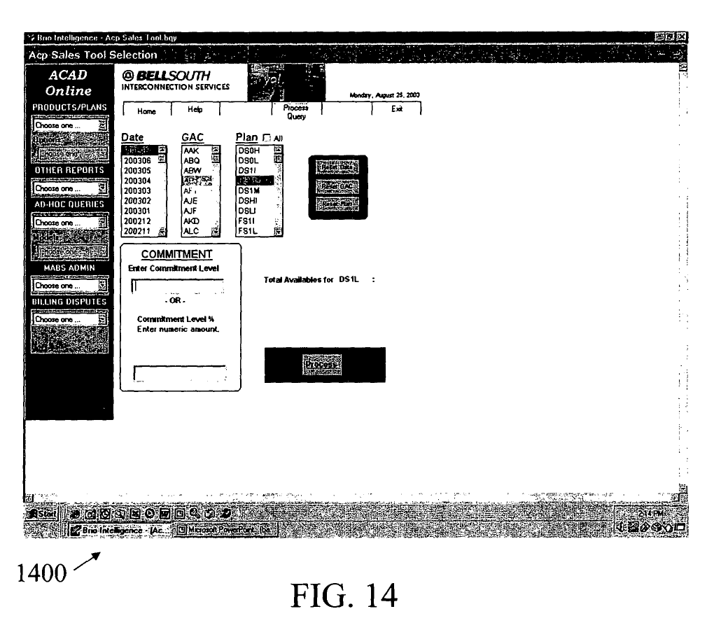

ACAD Online 316 maintains data for sixteen (16) Special Access ACP Plans and five (5) Switched Access ACP Plans. For each, the user can retrieve a pre-defined set of information that can then be submitted to a Microsoft Access program in order to calculate the amount of credit the customer would receive if they were to sign up for the savings plan. FIG. 14 illustrates a GUI for ACP simulation selection screen 1400. The user selects the plan(s) he/she is interested in and then supplies the GAC, ACNA, and Month. Queries are then run against the ACAD-C databases to retrieve the records that meet the criteria for that plan. For each plan type selected, a text file is created from the results set and is then saved to the user's hard drive with a unique name in a designated folder. After processing all the selected plans, the Microsoft Access program is launched and an ACP simulation detail based on the selections is generated (not shown).

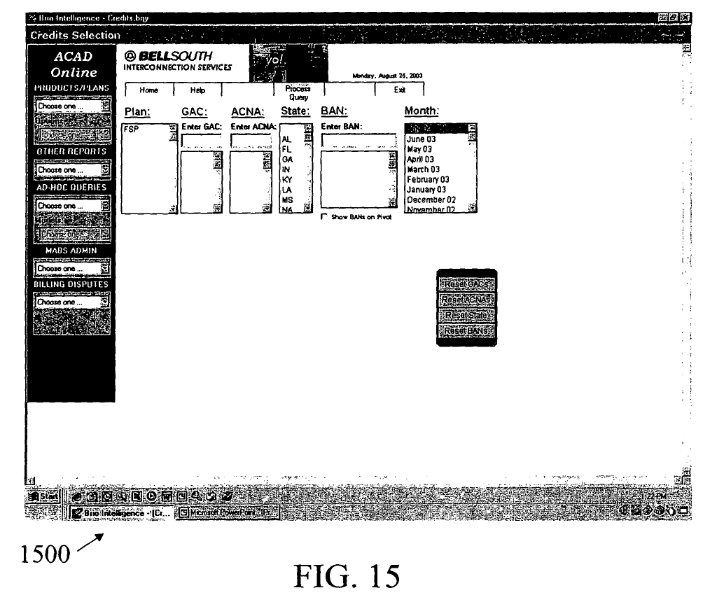

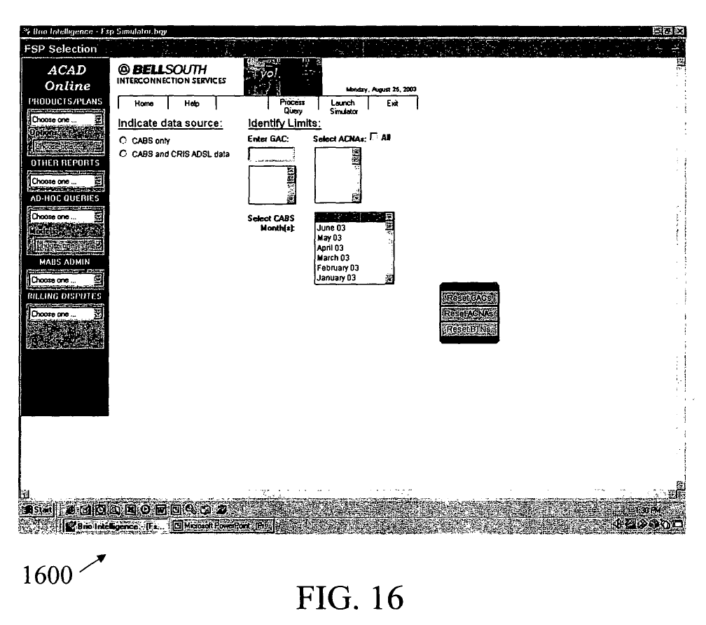

FIG. 15 illustrates a GUI for a Fast Packet Savings (FSP) plan OC&C credits selection screen 1500 from the data stored in the ACAD-B database and based on the user's selection criteria. The query limits by phrase code based on the plan type option selected by the user. For FSP, the phrase code is set to Z04. FIG. 16 illustrates a GUI for launching an FSP simulator selection screen 1600. The FSP simulator creates text files for the FSP Plan from CABS data or CABS and CRIS ADSL data. A separate file is created for each data source that is then saved to the user's hard drive with a unique name in a designated folder. After processing all the selected plans, a Microsoft Access® program is launched that uses the file in its report generation. The user chooses GACs, ACNAs, and Bill Months. If the choice is made to include CRIS ADSL data, the user must then enter billing numbers, also.

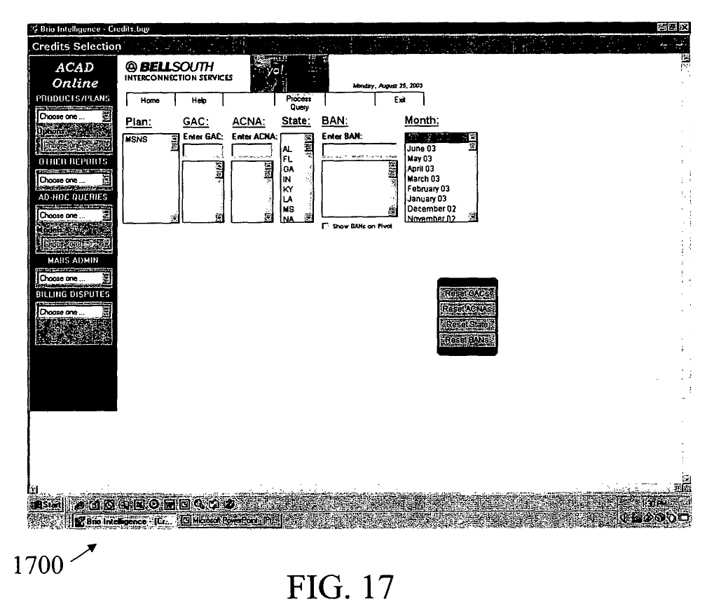

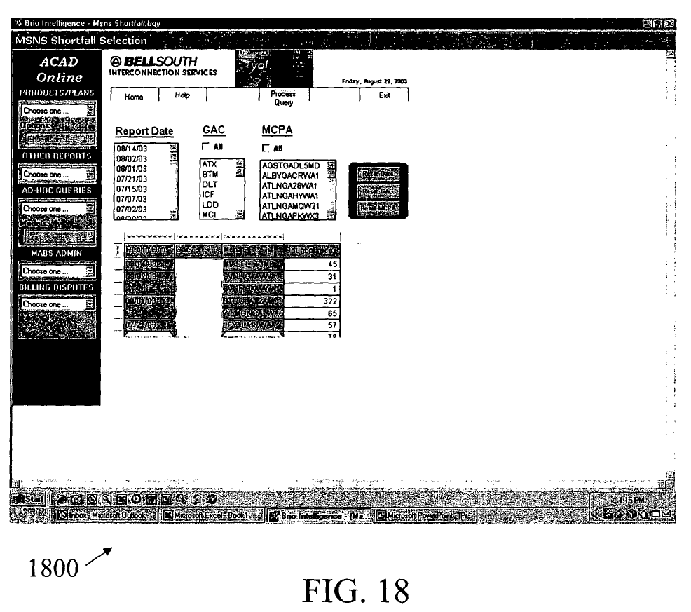

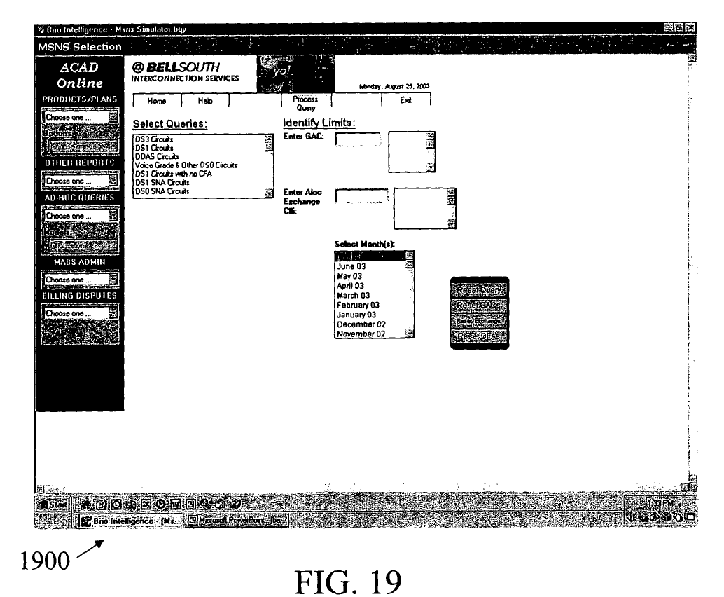

FIG. 17 illustrates a GUI for a Managed Shared Network Services (MSNS) selection screen 1700. Using the selection screen 1700, the user selects one or more GACs and one or more associated Managed Commitment Plan Arrangements (MCPAs) for those GACs. A query is then run to produce a report that shows the Point of Presence (POP) Common Language Location Identifier (CLLI) Addresses, the ACTLs, the Service Type of those ACTLs, and any user-defined notes for the selected GAC/MCPA. In addition, an MSNS plan OC&C credits detail stored in ACAD-B may be generated. The MSNS plan OC&C credits detail may be limited by phrase code based on the plan type option selected by the user. For MSNS, the phrase code is set to D70 and Z60. FIG. 18 illustrates a GUI for a CABS MP-10522 Shortfall selection screen 1800. The MP-10522 Shortfall detail (not shown) displays GACs by MCPA and ACM that had MSNS shortfall. It contains shortfall data extracted from CABS. The selection screen 1900 provides the options to select the date, GAC, and MCPA that are used to define the report criteria. A detail may be shown at the bottom of the selection screen 1900 that lists a summary of shortfall data. FIG. 19 illustrates a GUI for launching an MSNS Simulator selection screen 1900. The user inputs selections to run a query that identifies the ACAD-C MSNS circuits: circuit type (i.e. DS3, DS1, etc.), GAC, ALOC Exchange Common Language Location Identifier (CLLI), and Month. Connecting Facility Assignments (CFAs) may also have to be entered depending on the circuit type selected.

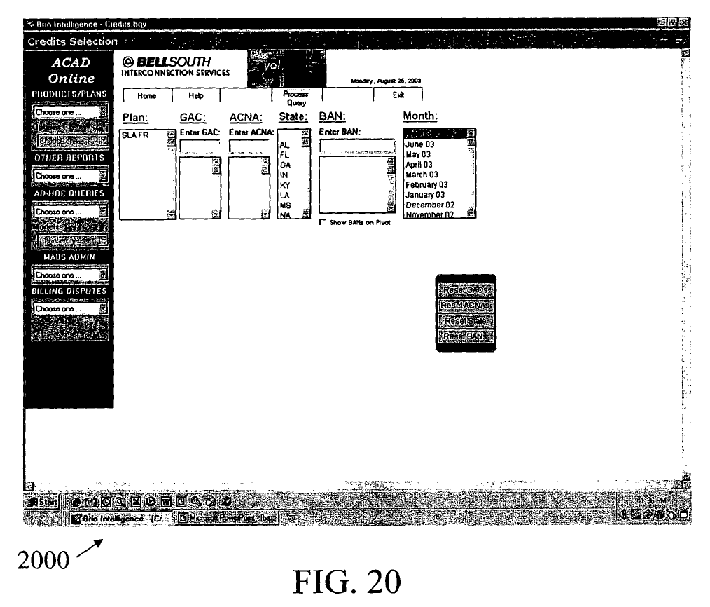

FIG. 20 illustrates a GUI for generating an SLA (Service Level Agreement) for Frame Relay (FR) plan OC&C credits 2000 stored in ACAD-B based on the user's selection criteria and produces the SLA for Frame Relay plan OC&C detail (not shown). The query limits by phrase code based on the plan type that the option is called from. For SLA FR, the phrase code is set to ZBF.

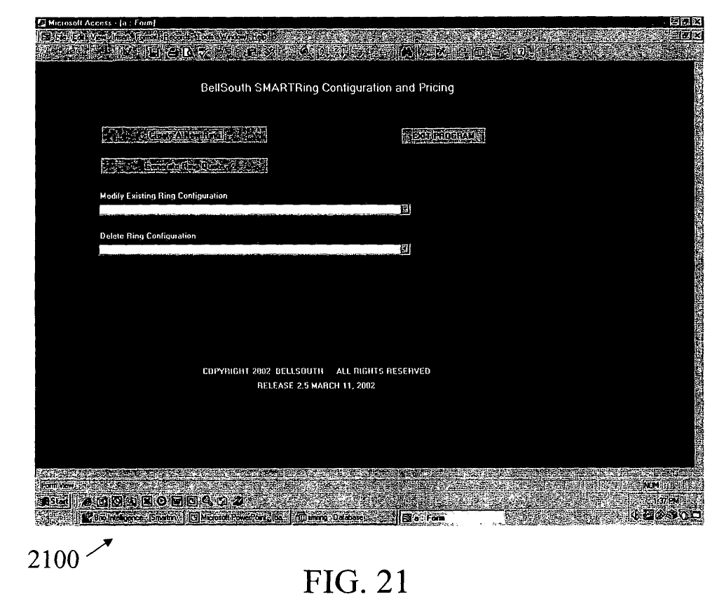

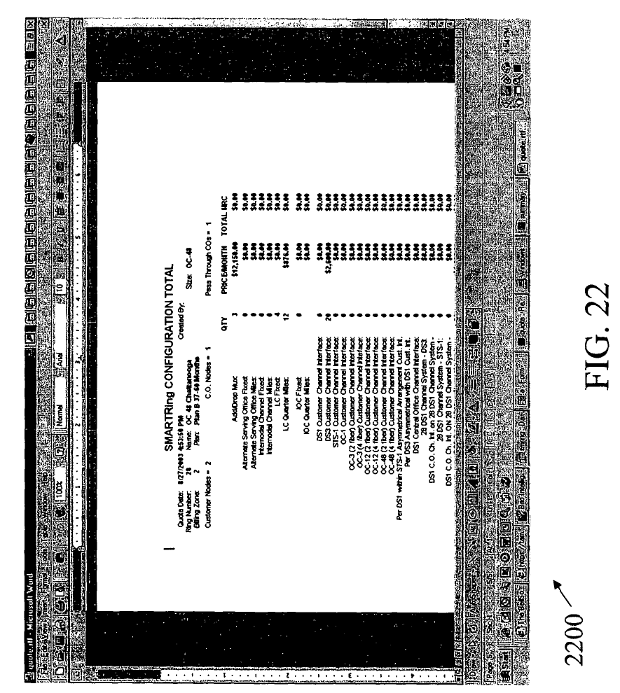

FIG. 21 illustrates a GUI for generating a SMARTRing detail 2100 that launches a Microsoft Access® program to allow the user to create various SMARTRing Sales proposal scenarios. FIG. 22 illustrates a GUI of a resulting SMARTRing sales proposal report 2200.

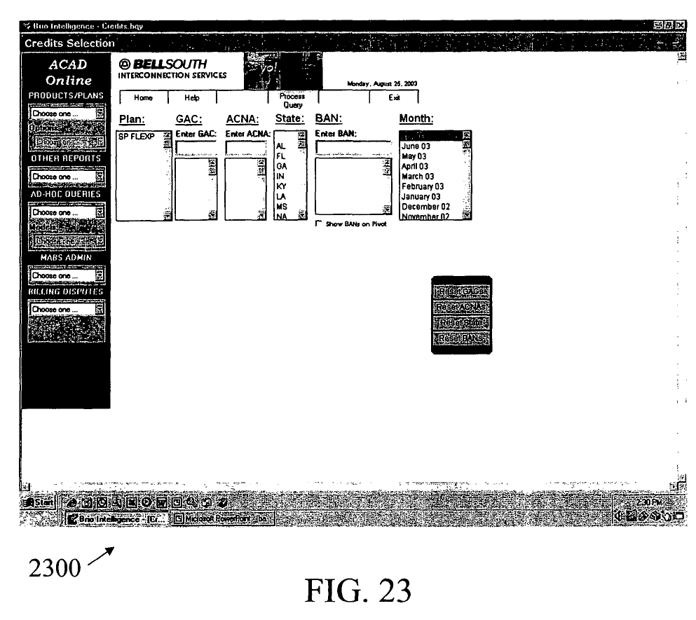

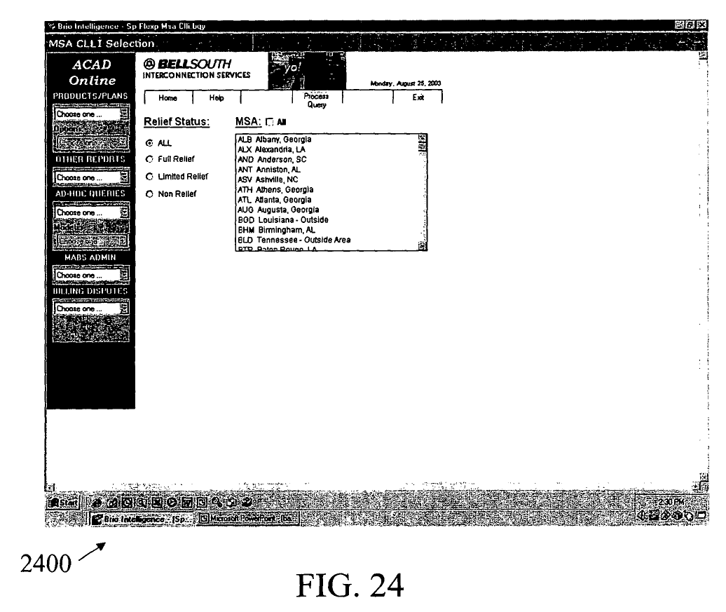

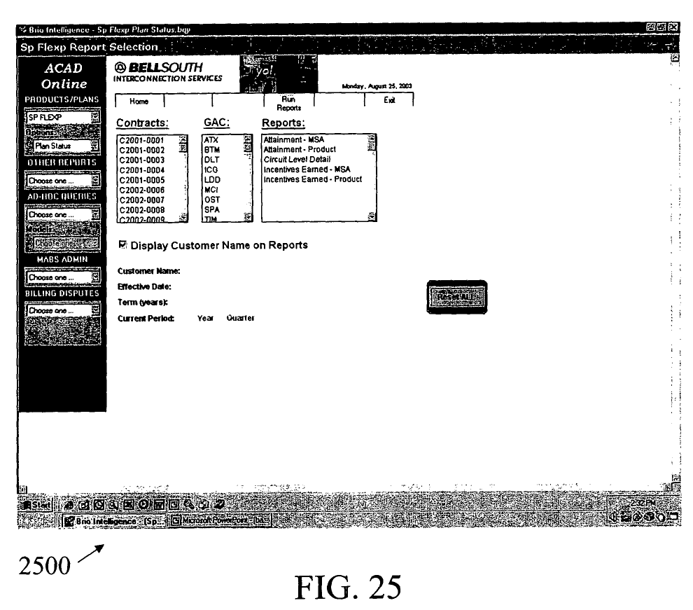

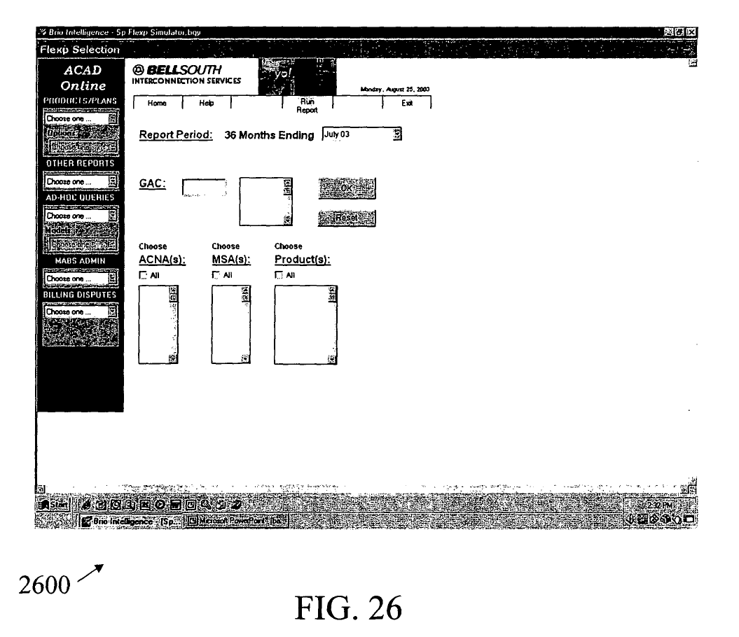

FIG. 23 illustrates a GUI for generating a Pricing Flexibility (e.g., Special Access Flexible Pricing (SP FLEXP)) selection screen 2300. The resulting detail shows all the terms, commitments and credits associated with an SP FLEXP contract. It is sourced the SP FLEXP contract extracted from the SP FLEXP Contract Tool. The selection screen 2300 provides the option to select the Contract ID that is used to define the detail criteria. In addition, a SP FLEXP plan OC&C credits screen (not shown) limited by phrase code based on the plan type may also be generated. For SP FLEXP, all phrase codes ZAD, ZAG, ZAI, ZAH, ZAE, ZAJ, ZAF, ZAL, ZAK, ZAU, ZAW, ZAN, ZAT, ZAM, ZAS, ZBM, ZBN, ZBO, and ZBP may be extracted. FIG. 24 illustrates a GUI for generating a SP FLEXP Metropolitan Statistical Area (MSAs) detail 2400. The user selects one or more MSAs and then indicates if All MSAs, Full Relief MSAs, Limited Relief MSAs, or Non Relief MSAs should be included. FIG. 25 illustrates a GUI for accessing five details pertaining to SP FLEXP revenue and credits 2500. The Attainment—MSA detail displays the SP FLEXP Regional level revenue attainment by GAC and Contract. The user has the option of choosing the date range on the report. The report displays the YTD revenue and commitment target in graphical representation and computes a percent attainment. It also displays a pivot of revenue by MSA and Bill Month. The Attainment—Product detail displays the SP FLEXP Regional level Product Suite revenue attainment by GAC and Contract. The user has the option of choosing the date range on the detail. The detail displays the YTD Product Suite revenue and commitment target in graphical representation and computes a percent attainment. It also displays a pivot of Product Suite revenue by MSA and Bill Month. The Circuit Level Detail displays SP FLEXP revenue at circuit level by Customer and Contract. The user has the option of choosing the date range on the report. The Incentives Earned—MSA detail displays regional SP FLEXP Regional and Product Suite credits accrued by Customer and Contract. The user has the option of choosing the date range on the report. The credit amounts are in Pivot format that are at MSA and Billing Account Number (BAN) level. The Incentives Earned—Product detail displays regional SP FLEXP Product Incentive credits accrued by Customer and Contract. The user has the option of choosing the year on the report. The amounts are at MSA and BAN level. FIG. 26 illustrates the GUI for launching the SP FLEXP Simulator 2600. The SP FLEXP Simulator is a Sales Tool for the SP FLEXP Credits team. The SP FLEXP Simulator displays the revenue trends by Carrier and aids sales personnel in computing contract commitments. The SP FLEXP Simulator detail is a single report that combines charts, pivots and computed fields to reveal 3 years of annual revenue and trending percentages. The data is grouped by GAC, MSA, and product and revenue is displayed at the Total, Relief qualifying and product level.

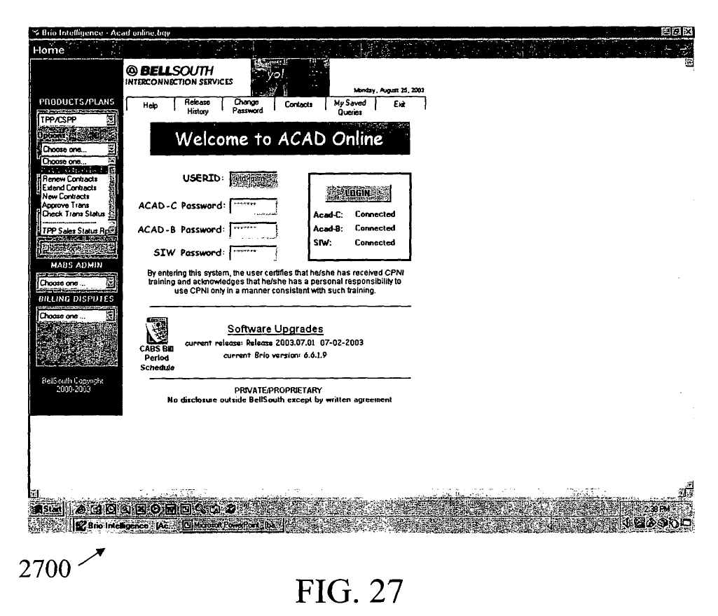

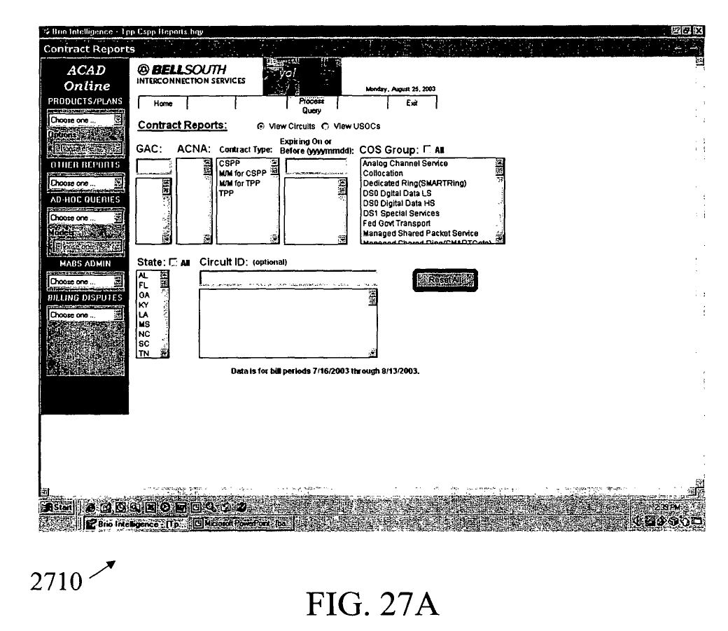

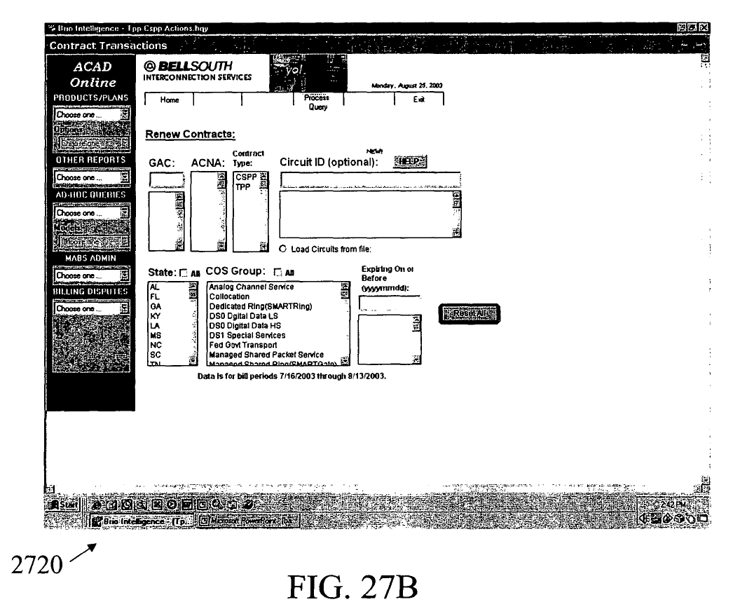

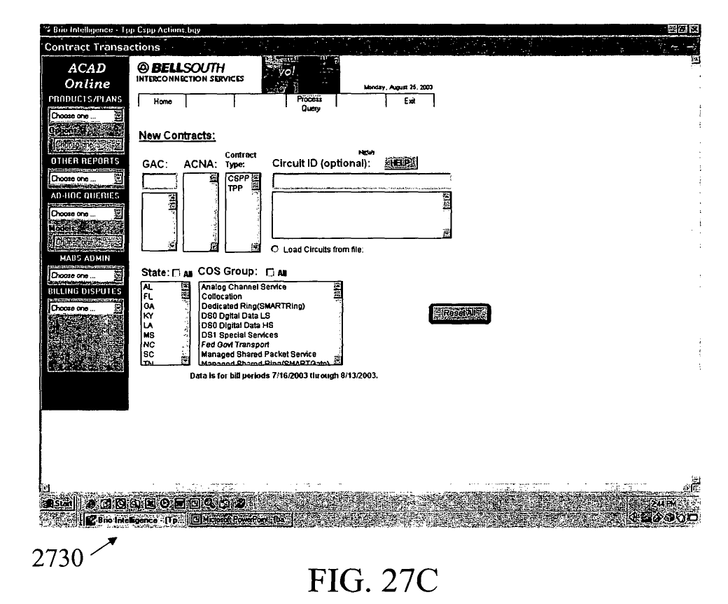

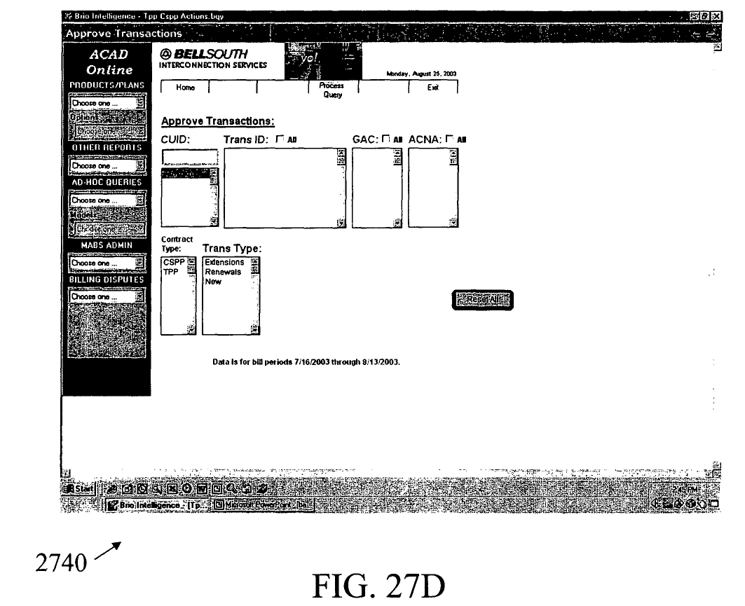

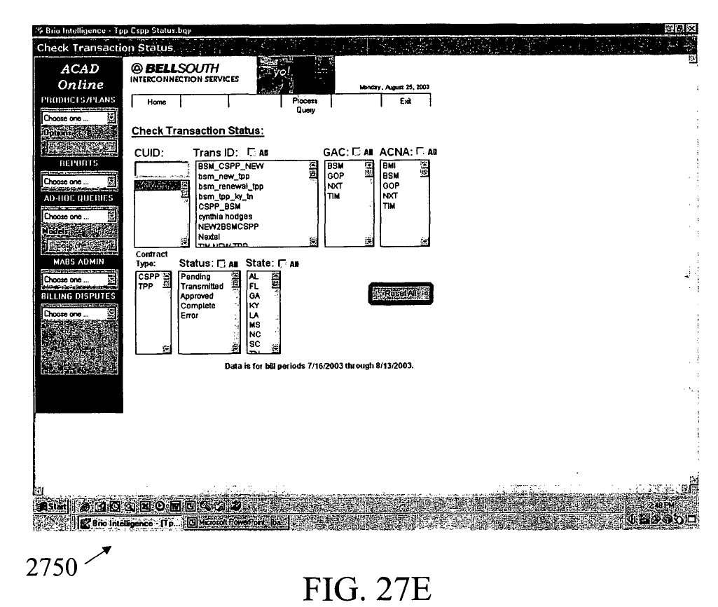

FIG. 27 illustrates a GUI for a TPP/CSPP selection screen 2700. The user can use the selection screen 2700 to create details of customers with TPP or CSPP contracts or customers who currently do not have one of these contracts (currently month to month full rate basis), but are eligible to have one. The selection screen 2700 allows the user to do access other GUIs (shown as reference numerals 2700A-E) to manage several different actions relating to TPP and CSPP contracts: 1) view existing contract details 2700A; 2) renew existing contracts using GUI 2700B; 3) extend existing contracts using GUI 2700C; 4) create new contracts on circuits that are currently month-to-month using GUIs 2700D; and 5) approve contract transactions using GUIs 2700E. To renew an existing contract, the user must enter the GAC, ACNA, contract type (TPP or CSPP), state, and class of service group of the circuits that need to be renewed. A date that the contract is expiring on or before must also be entered. When the “Process Query” label is clicked, a query is run against ACAD-C to bring back all selected circuits and display them on a separate GUI. The user then supplies the transaction id, an email address, the new contract term (months), the new rate date, the CABS effective date, and any notes for the circuits whose contracts he/she wished to renew. When a “Process” command button is clicked (e.g., the “Process” button displayed on the screen to generate the pivot detail report), the information supplied by the user is edited and then transactions are created for the selected circuits and stored. On the next bill date, approved records are sent to CABS where the contracts are renewed. To extend contracts, this option works almost identical to contract renewal with the only difference being that the user does not enter a new rate date. To enter a new contract, the user can obviously not enter a contract expiration date when querying the database since the goal is to identify circuits currently not under contract. With this one difference, the other steps are the same as for renewals and extensions. To approve renewed, extended, or new transactions, the user identifies the circuits by either CUID, transaction id, GAC, ACNA, contract type, or transaction type (extend, renew, new) and then indicates if the transaction should be approved or deleted. In addition, ACAD Online includes a GUI for allowing the user to check the status of previously submitted TPP/CSPP contract transaction (the GUI is not shown due to privacy regulations). When the contract transaction is selected and opened, it automatically queries the transactions belonging to the user's CUID and displays the data in selection list boxes. The user can then narrow the query by selecting additional criteria and click a “Process Query” label to run the query and produce a detail.

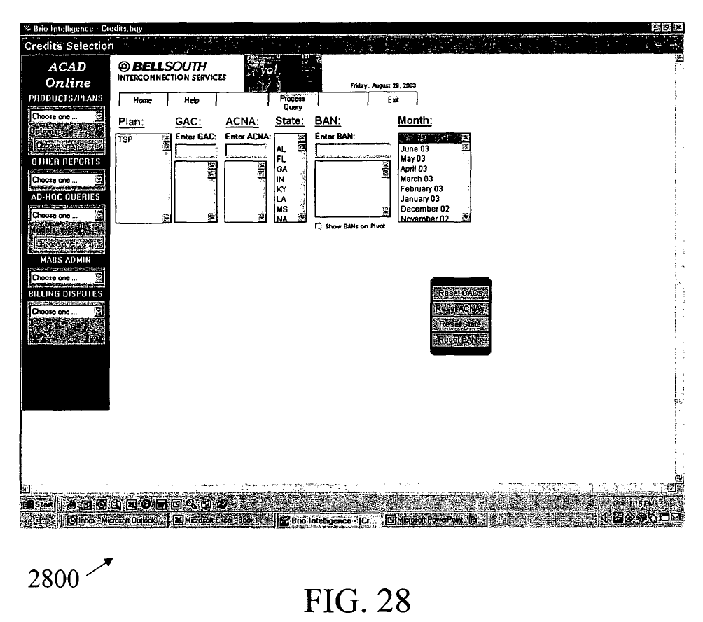

FIG. 28 illustrates a GUI for a Transport Savings Plan (TSP) selection screen 2800. The TSP detail (not shown) is based on TSP plan OC&C credits. The query limits by phrase code based on the plan type that the option is called from. For TSP, the phrase code is set to H39. FIG. 29 illustrates a GUI for launching a TSP Simulator 2900. Using the selection criteria, either a summarized text file for TSP or two detailed text TSP files, based on the user's selection of either a “summarized” or a “detailed” query level are provided. The files are then saved to the user's hard drive with a unique name in a designated folder. After processing, a Microsoft Access® program is launched that uses the files in its report generation. The user chooses one or more GACs, ACNAs, and Bill Dates.

ACAD Other Reports

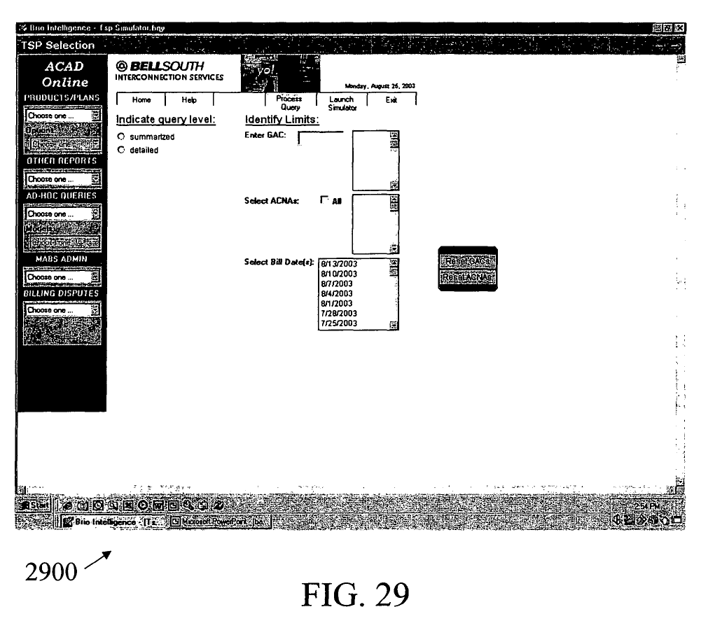

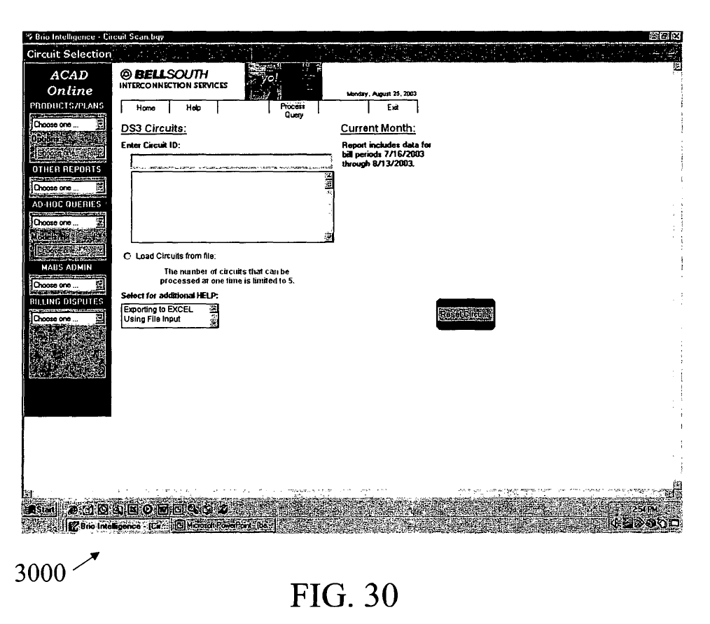

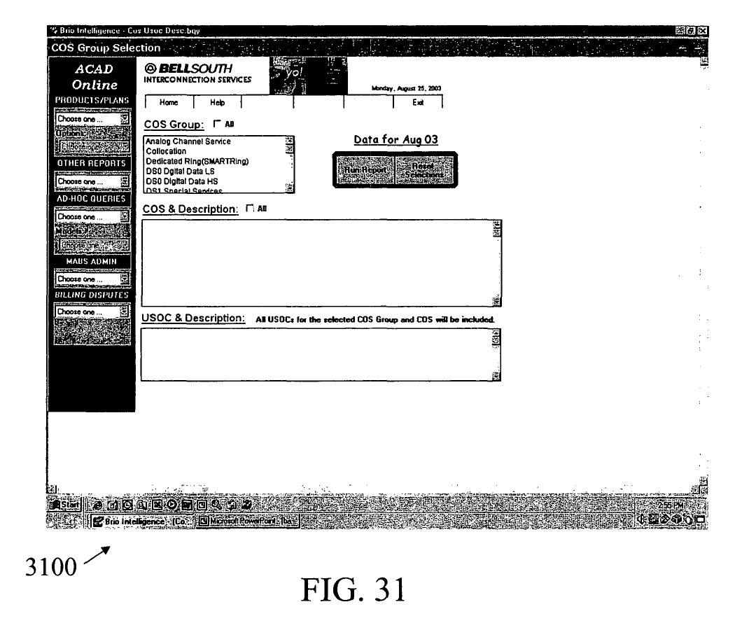

Other reports 420 may be generated using the GUIs 3000 and 3100 of FIGS. 30 and 31. FIG. 30 illustrates the GUI 3000 for circuits scanned based on selection criteria. FIG. 31 illustrates the GUI 3100 for generating a detail associated with the class of service (COS) and its description and the USOC and its description for each selected class of service group.

ACAD AD-HOC Queries

ACAD Online 316 includes pre-built data models that are used to access, read, merge, store, and maintain access carrier service rate and billing detail records. These data models can be used to build ad-hoc queries 430 without requiring the user to have an understanding of the underlying table joins in the ACAD-B or ACAD-C database.

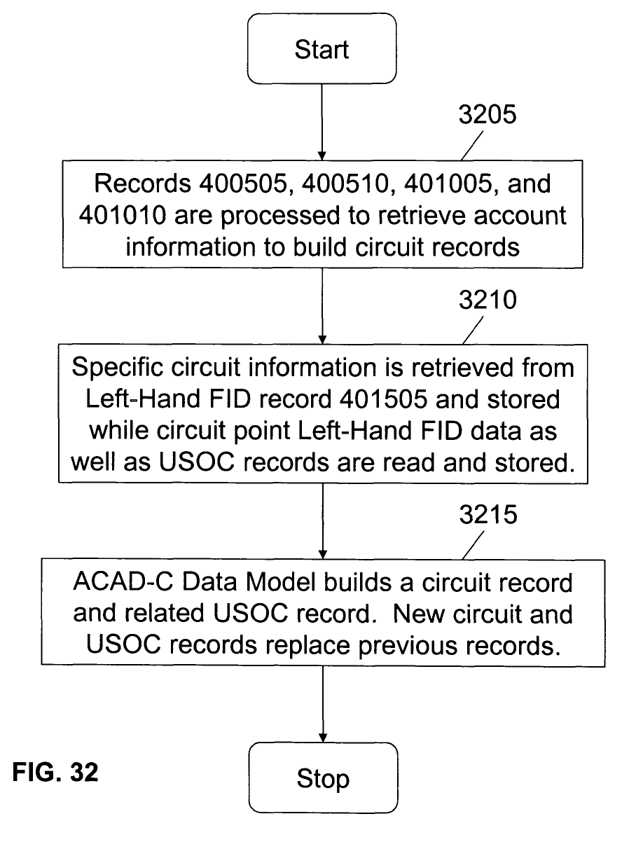

The ACAD-B models are based on the ACAD-B relational database. This database is built from CABS Billing Data Tape (BDT) and Customer Service Record (CSR) data with its main emphasis being the billing data. FIG. 32 illustrates a GUI for generating an ACAD-B Billing Summary detail 3200. This model provides information found on the Bill page for the customer, including current charges, late payment charges, OC&C charges, and billing name address. FIG. 33 illustrates a GUI for generating an ACAD-Miscellaneous Billing detail 3300 of miscellaneous billing data including billing and collections and OC&C detail. FIG. 34 illustrates a GUI for generating an ACAD-B Usage detail 3400 that provides usage detail revenue and usage statistics including minutes of use. FIG. 35 illustrates a GUI for generating an ACAD-B USOC detail 3500 found on the CABS Customer Service Record and the Billing Data Tape.

The ACAD-C model is based on the ACAD-C relational database. This database is built from CABS Customer Service Record (CSR) data and is available at a circuit level of detail. FIG. 36 illustrates a GUI for generating an ACAD-C Interexchange Carrier Access Billing System (ICABS) detail 3600 that provides complete customer detail information. The ACAD ICABS detail includes items such as GAC, ACNA, Customer Name, USOCs and their revenue and contract information, and circuits and their locations.

The MABS models are based on the representation of the billing CSR records. For each credit given, the customer, the BAN, and the amount of the credit can be queried, in addition to other information. Details that may be generated include an SLA for Frame Relay detail, an SP FLEXP revenue summary detail, an SW FLEXP usage detail, and an SW FLEXP USOC detail.

SIW

The Strategic Information Warehouse (SIW) includes the Integrated Customer Database (ICD). This database contains account, address, billing, USOC and working line service/product information from CRIS for the local service of residential and business customers. From these tables, various data models have been created for each type of customer including: Business, Competitive Local Exchange Carrier Business Master (CLEC Bus Master), CLEC Business, Competitive Local Exchange Carrier Residential Master (CLEC Res Master), CLEC Residence, and wireless.

ACAD MABS Admin

The access carrier service customer rate and billing information in MABS administration 440 is only accessible by a select group of users in additional processing for creating customer billing credits. This information include: (1) an Audit Ad Hoc FSP administrative section that provides holding FSP credits that were sent to CABS for the customer bill, (2) an Audit Ad Hoc TSP administrative section that details holding TSP credits that were sent to CABS for the customer bill, (3) an Audit Summary Report administrative section that produces a summary audit report of the FSP and TSP credits sent to CABS for the customer bill, (4) a MABS ADMIN Contracts administrative section that allows authorized users to administer FSP and TSP contracts (that is the users can add, delete, and update contracts, and produce reports of the contract information), (5) a COS Groups administrative section that allows authorized users to assign class of service groups to existing class of service USOCs, (5) a Managed Shared Network Service Access Carrier Termination Location (MSNS ACTLs) detail that allows authorized users to administer the MSNS ACTL table by: adding new GACs, adding new ACTLs to existing GACs, and deleting ACTLs from existing GACs, (6) an MSNS Adjustments administrative section that allows authorized users to administer the TSP MSNS Adjustments table by: adding new adjustments, updating adjustments, and/or deleting adjustments, (7) an SP FLEXP MSAs administrative section that allows authorized users to administer the Flexible Pricing Special Access MSA CLLIs by adding and deleting CLLIs to existing MSAs and generating additional reports of all CLLIs and CLLI history, (8) an Upload SLA Data administrative section that allows authorized users to upload an MS EXCELS spreadsheet with SLA credit percentages by ACNA, Phone Number, and Circuit, and after the records are edited, the circuit's total interstate revenue is retrieved, stored, and used in an Multiple Virtual Storage (MVS) process to create and send SLA credits to CABS to apply to the customers' bills, and (9) a USOCs administrative section that allows authorized users to administer the USOCs table by adding, updating, and deleting the USOCs by plan type.

While the methods and systems described herein and illustrated in the figures contain many specific systems and methods for selected carrier access customer service rate and billing detail, these systems and methods should not be construed as limitations on the scope of the invention, but rather each is an example of an embodiment. For example, the above figures of exemplary GUIs include display screens, toolbar menus, and tab menus that illustrate systems and methods for executing exemplary carrier access service customer rate and billing detail via ACAD Online 316. As would be apparent to one of ordinary skill in the art, many other variations on the systems and methods are possible, including differently grouped and ordered systems and method steps. Accordingly, the scope of the invention should be determined not by the embodiments illustrated, but by the appended claims and their equivalents.

What is claimed is:

1. A method comprising the steps of:
accessing a regional rate record of a customer from a local exchange routing guide information system, wherein the regional rate record is accessed from multiple customer operations units and multiple revenue accounting offices, and wherein the local exchange routing guide information system maintains routing and rate records for terminating a telephone call to an appropriate telephone number at a proper rate;
accessing a billing record of the customer from a carrier access billing system, wherein the billing record is accessed from the multiple customer operations units and the multiple revenue accounting offices, and wherein the carrier access billing system maintains billing records for wholesale customers that purchase blocks of telephone capacity;
associating the regional rate records with the billing record to create a compiled rate and billing record; and
creating an access carrier service rate and billing detail based on the compiled rate and billing record, the access carrier service rate and billing detail comprising data associated with at least one of a customer, a service agreement, a service usage, a service rate, service availability, a type of service, and a service region.

2. The method of claim 1 further comprising the step of:
using the access carrier service rate and billing detail to manage an access carrier rate and billing plan.

3. The method of claim 2, wherein the step of using the access carrier service rate and billing detail to manage the access carrier rate and billing plan comprises creating and updating at least one of terms, conditions, discounts, and promotions of the access carrier rate and billing plan.

4. The method of claim 1 further comprising the steps of:
reporting the access carrier service rate and billing detail of the customer; and
providing means for modifying the access carrier service rate and billing detail.

5. The method of claim 1, wherein step of creating the access carrier service rate and billing detail based on the compiled rate and billing record comprises presenting a view of at least one of groups of accounts under one access carrier customer, relations between a plurality of access carrier customers, and unique access carrier customer-based information.

6. The method of claim 1, further comprising the step of:
displaying at least one of alternate promotional codes, rate plans, and service agreements.

7. The method of claim 6, wherein the step of displaying at least one of alternate promotional codes, rate plans, and service agreements further comprises the steps of:
retrieving, from the local exchange routing guide information system and the carrier access billing system, data relevant to terms and conditions of the access carrier service rate and billing detail;
calculating a discount based on the data relevant to the terms and conditions;
creating an other-charge-and-credit based on the discount; and
if authorized by the customer, passing the other-charge-and-credit to the local exchange routing guide information system and the carrier access billing system for inclusion on the access carrier rate and billing plan.

8. A system comprising:
a local exchange routing guide information system, wherein the local exchange routing guide information system maintains routing and rate records for terminating a telephone call to an appropriate telephone number at a proper rate;
a carrier access billing system, wherein the carrier access billing system maintains billing records for wholesale customers that purchase blocks of telephone capacity;
an access carrier service rate and billing details management application that
interfaces with the local exchange routing guide information system and the carrier access billing system,
accesses a regional rate record of a customer from the local exchange routing guide information system, wherein the regional rate record is accessed from multiple customer operations units and multiple revenue accounting offices,
accesses a billing record of the customer from the carrier access billing system, wherein the billing record is accessed from the multiple customer operations units and the multiple revenue accounting offices,
associates the regional rate record with the billing record to create a compiled rate and billing record,
creates and maintains a selected view associated with one or more compiled rate and billing records, the selected view comprising compiled rate and billing records associated with at least one of a customer, a service agreement, a service usage, a service rate, service availability, a type of service, and a service region,
provides means to establish, monitor, take action on, and report on customer terms and conditions, and
supports online tasks and offline data maintenance and exchange.

9. The system of claim 8, wherein the access carrier service rate and billing details management application comprises at least one of an online portion, a database, a report generator, an offline interface, an online interface, an interface for updating changes to existing systems, and an other application interface.

10. The system of claim 9, wherein the online portion comprises a graphical user interface, an application server, and a database server.

11. The system of claim 10, wherein the graphical user interface is displayed on a client workstation.

12. The system of claim 11, wherein the client workstation comprises at least one of the following:
a wireless communications device,
a mobile phone,
a cellular phone,
a WAP phone,
a satellite phone
a computer,
a modem,
a pager,
a digital music device,
a digital recording device,
a personal digital assistant,
an interactive television,
a digital signal processor, and
a Global Positioning System device.

13. The system of claim 10, wherein the application server resides on a UNIX-based system.

14. The system of claim 10, wherein the database resides on a UNIX-based system.

15. The system of claim 10, wherein the application server resides on a LINUX-based system.

16. The system of claim 10, wherein the database resides on a LINUX-based system.

17. The system of claim 10, wherein the online interface communicates with an object management software.

18. The system of claim 10, wherein the offline interface is coded in a business application computer programming language.

19. The system of claim 17, wherein the other application interface communicates with the object management software.

20. A system comprising:
a client system containing a client program;
an application server containing an application server program; and
a database server containing a database,
wherein in response to a user request for an access carrier service rate and billing details through the client system, the application server program retrieves information from the database, the application server program performs any required business logic, the application server program returns the information to the client program, and the client program formats and displays the access carrier service rate and billing details on a screen for the user,
wherein the application server contains business applications and legacy applications,
wherein the business applications comprise an access carrier service rate and billing details manager application, and wherein the legacy applications comprise a local exchange routing guide information system and a carrier access billing system,
wherein the local exchange routing guide information system maintains routing and rate records for terminating a telephone call to an appropriate telephone number at a proper rate,
wherein the carrier access billing system maintains billing records for wholesale customers that purchase blocks of telephone capacity, and
wherein the information retrieved from the database comprises at least one of
a regional rate record from the local exchange routing guide information system, and
a billing record from the carrier access billing system.
